(19) United States
(12) Patent Application Publication
(10) Pub. No.: US 2016/0297902 A1
(43) Pub. Date: Oct. 13, 2016

(54) METALLOCENE CATALYST SYSTEM COMPRISING ANTISTATIC AGENT AND METHOD FOR PREPARING POLYOLEFIN USING THE SAME

(71) Applicant: HANWHA CHEMICAL CORPORATION, Seoul (KR)

(72) Inventors: Hyun Seung LEE, Gwangju (KR); Jun Ho SEO, Ulsan (KR); Dong Wook JEONG, Daejeon (KR); Eun Jung HEO, Daejeon (KR)

(73) Assignee: HANWHA CHEMICAL CORPORATION, Seoul (KR)

(21) Appl. No.: 14/777,775

(22) PCT Filed: Apr. 2, 2014
(86) PCT No.: PCT/KR2014/002852

§ 371 Date: Sep. 17, 2015

(30) Foreign Application Priority Data
Apr. 8, 2013 (KR) 10-2013-0038150
Feb. 17, 2014 (KR) 10-2014-0018047

(51) Int. Cl. C08F 110/02

(52) U.S. Cl. CPC C08F 110/02

(57) ABSTRACT

The present invention relates to a metallocene catalyst system comprising an antistatic agent and a preparation method for polyolefin using the same. The present invention can not only maintain the inherent activity of the catalyst but also minimize reactor fouling and particle agglomeration in the preparation of a polyolefin using the gas-phase polymerization process, thereby allowing to the process to be operational with more stability.

### TECHNICAL FIELD

The present invention relates to a metallocene catalyst system comprising antistatic agents and a preparation method for polyolefin using the same.

The present application claims the priority benefit of Korean Patent Application No. 10-2013-0038150 filed on Apr. 8, 2013 and Korean Patent Application No. 10-2014-0018047 filed on Feb. 17, 2014, which is herein incorporated by reference in their entirety.

### BACKGROUND OF ART

As well known, industrial production methods for polyolefin from olefin include solution polymerization process, slurry polymerization process, and gas-phase polymerization process. The solution polymerization process produces involves polymerization of a polymer dissolved in the state of solution. The slurry polymerization process results in a solid-state polymer dispersed in a liquid-state polymerization medium. The gas-phase polymerization process produces a polymer dispersed in a fluidized state in a gaseous polymerization medium.

Generally, the gas-phase polymerization process is carried out at a temperature lower than the melting temperature of the polymer. In the gas-phase polymerization procedure, the temperature tends to rise above the threshold temperature due to several reasons as high as to soften the polymer, causing the polymer to agglomerate or build up on the wall of the reactor. Hence, the gas-phase polymerization process inevitably leads to reactor fouling with polymer particles building up on the inner wall of circulating gas pipes, a heat exchanger or a condenser and forms polyolefin agglomerates in the vicinity of the softening temperature. These phenomena may be affected by the polymerization medium, the molecular weight of the polymer, the concentration of comonomers, or the like and become worse as the polymer has the smaller particle size.

When reactor fouling and particle agglomeration become more severe in the gas-phase polymerization process, it is hard to achieve heat transfer and heat removal in the reactor, hindering a normal transfer of polyolefin and making it impossible to accomplish an effective control of the polymerization reaction and a long-term performance of the polymerization reaction, consequently with deterioration in the production efficiency.

Accordingly, many attempts have been made to minimize occurrence of reactor fouling and particle agglomeration in the polyolefin production. For example, U.S. Pat. No. 4,650,841 discloses a method of preventing reactor fouling by reducing the catalytic activity with a deactivating agent; and U.S. Pat. No. 5,733,988 describes a method of using alcohol, ether, ammonia, or the like as an antifouling agent. However, these methods are to lower the activity of catalysts, deteriorating the activity of the reaction and thus inevitably resulting in low production efficiency. Furthermore, U.S. Pat. No. 5,270,407 discloses a method of preventing reactor fouling by adding polysiloxane to the catalyst system; and U.S. Pat. No. 3,956,257 describes a method of preventing reactor fouling with hydrocarbyl aluminum alkoxide. These methods also adversely lead to reduction of the catalytic activity on the whole.

### DETAILED DESCRIPTION OF THE INVENTION

### Technical Problem

Accordingly, the present invention is to provide a metallocene catalyst system that can not only maintain the inherent activity of the catalyst but also minimize reactor fouling and particle agglomeration in the preparation of a polyolefin using the gas-phase polymerization process, thereby allowing to the process to be operational with more stability.

The present invention is also to provide a method for preparing a polyolefin using the catalyst system.

### Technical Solution

According to the present invention, there is provided a metallocene catalyst system for olefin polymerization comprising:

a metallocene compound; and

at least one antistatic agent selected from an alkali metal salt and an alkaline earth metal salt.

In this regard, the antistatic agent may be a compound comprising at least one metal selected from the group consisting of lithium, sodium, potassium, rubidium, cesium, francium, calcium, strontium, barium, and radium.

Further, the antistatic agent may be used in such an amount that the molar ratio of a metal contained in the antistatic agent with respect to one mole of a transition metal contained in the metallocene compound is in the range of 1:0.001 to 1:100.

The metallocene compound may be a compound represented by the following formula 1:

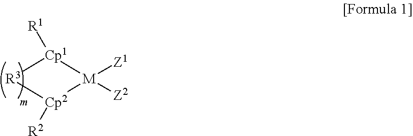

in the formula 1,

M is a transition metal of group 4;

Cp¹ and Cp² are the same or difference and each is independently any one radical selected from the group consisting of cyclopentadienyl, indenyl, 4,5,6,7-tetrahydro-1-indenyl, and fluorenyl and replaceable by at least one hydrocarbon group having 1 to 20 carbon atoms;

R¹ and R² are the same or difference and each is independently a hydrogen, an alkyl group having 1 to 20 carbon atoms, an alkoxy group having 1 to 10 carbon atoms, an alkoxyalkyl group having 1 to 20 carbon atoms, an aryl group having 6 to 20 carbon atoms, an aryloxy group having 6 to 10 carbon atoms, an alkenyl group having 2 to 20 carbon atoms, an alkylaryl group having 7 to 40 carbon atoms, an arylalkyl group having 7 to 40 carbon atoms, an arylalkenyl group having 8 to 40 carbon atoms, or an alkynyl group having 2 to 10 carbon atoms;

R³ is a divalent hydrocarbon group crosslinking Cp¹R¹ and Cp²R² through a covalent bond and containing an element selected from the group consisting of silicon, germanium, phosphor, nitrogen, boron, and aluminum; and

m is 0 or 1.

The metallocene catalyst system for olefin polymerization may further comprise a cocatalyst compound.

Further, the metallocene catalyst system for olefin polymerization may further comprise an inert support to which the metallocene compound and the antistatic agent are affixed.

On the other hand, according to the present invention, there is provided a method for preparing a polyolefin that comprises performing gas-phase polymerization of at least one olefin monomer in the presence of the aforementioned metallocene catalyst system.

In this regard, the olefin monomer may be at least one compound selected from the group consisting of an alpha-olefin having 2 to 20 carbon atoms, a diolefin having 1 to 20 carbon atoms, a cyclo-olefin having 3 to 20 carbon atoms, and a cyclo-diolefin having 3 to 20 carbon atoms.

### Advantageous Effects

The metallocene catalyst system of the present invention can not only maintain the inert activity of the catalyst but also minimize reactor fouling and particle agglomeration in the preparation of a polyolefin using the gas-phase polymerization process, thereby allowing the process to be operational with more stability.

### BRIEF DESCRIPTION OF DRAWINGS

FIG. 1 is a graph showing the change of temperature on the inner wall of the reactor in the preparation of a polyolefin using a catalyst system according to one embodiment of the present invention.

FIG. 2 is a graph showing the change of temperature on the inner wall of the reactor in the preparation of a polyolefin using a catalyst system according to a comparative example of the present invention.

### MODES FOR CARRYING OUT THE INVENTION

Hereinafter, a description will be given as to a metallocene catalyst system and a method for preparing a polyolefin using the same according to exemplary embodiments of the present invention.

The terminology used herein is for the purpose of describing an embodiment only and is not intended to be limiting of an exemplary embodiment. As used herein, the singular forms are intended to include the plural forms as well, unless the context clearly indicates otherwise. It will be further understood that the terms “comprises” and/or “contains” when used in this specification, specify the presence of stated feature, region, integral number, step, operation, component, or element, but do not preclude the presence or addition of one or more other features, integral numbers, steps, operations, components, or elements.

The inventors of the present invention have made sustained studies on the preparation method for polyolefin and found out the fact that a metallocene catalyst system comprising an alkali metal salt, an alkaline earth metal salt, or a mixture thereof can be used to minimize reactor fouling and particle agglomeration without deteriorating the inherent activity of the catalyst and thereby to allow the process to be operational with more stability and efficiency.

In accordance with one exemplary embodiment of the present invention, there is provided a metallocene catalyst system for olefin polymerization comprising:

a metallocene compound; and

at least one antistatic agent selected from an alkali metal salt and an alkaline earth metal salt.

In other words, the metallocene catalyst system comprising at least one compound selected from the group consisting of an alkali metal salt and an alkaline earth metal salt can not only minimize static electricity produced by the friction between polymer particles or between the polymer particles and the inner wall of the reactor in the preparation of a polyolefin, particularly using the gas-phase polymerization process, but also stably maintain the inherent activity of the catalyst. This presumably results from the function of the metallocene catalyst system according to one exemplary embodiment to form a polymer in the reactor that has such a particle size and a bulk density as to minimize the occurrence of static electricity created by the friction.

According to the present invention, the antistatic agent may be at least one selected from an alkali metal salt and an alkaline earth metal salt. More specifically, the antistatic agent may be a compound comprising at least one metal selected from the group consisting of lithium, sodium, potassium, rubidium, cesium, francium, calcium, strontium, barium, and radium. Particularly, the antistatic agent is preferably at least one compound selected from the group consisting of lithium chloride, sodium chloride, and calcium chloride, with a view to minimizing the deterioration in the activity of the catalyst but offering a sufficient antistatic effect and securing good availability.

In this regard, the antistatic agent may be used in such an amount that the molar ratio of a metal contained in the antistatic agent with respect to one mole of a transition metal contained in the metallocene compound is in the range of 1:0.001 to 1:100, or 1:0.01 to 1:100, or 1:0.1 to 1:100. In other words, to sufficiently acquire the antistatic effect required by the present invention, the antistatic agent is preferably used in such an amount that the molar ratio of a metal contained in the antistatic agent with respect to one mole of a transition metal contained in the metallocene compound is in the range of 1:0.001 or greater. But, an excess of the antistatic agent used in the catalyst system leads to deterioration in the enhancement of the antistatic effect with respect to the added amount of the antistatic agent and decreases the activity of the catalyst by way of the reaction between the antistatic agent and the catalyst. Accordingly, it is preferable to use the antistatic agent in such an amount that the molar ratio of a metal contained in the antistatic agent with respect to one mole of a transition metal contained in the metallocene compound is in 1:100 or less.

In other words, the content of the antistatic agent may be approximately in the range from 0.1 wt. % to 5 wt. % with respect to the total weight of the metallocene compound.

On the other hand, the metallocene catalyst system of the present invention may include a typical metallocene compound, of which the composition is not specifically limited.

In accordance with one exemplary embodiment of the present invention, the metallocene compound may be a compound represented by the following formula 1:

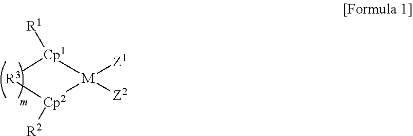

In the formula 1,

M is a transition metal of group 4;

Cp¹ and Cp² are the same or difference and each is independently any one radical selected from the group consisting of cyclopentadienyl, indenyl, 4,5,6,7-tetrahydro-1-indenyl, and fluorenyl and replaceable by at least one hydrocarbon group having 1 to 20 carbon atoms;

R¹ and R² are the same or difference and each is independently a hydrogen, an alkyl group having 1 to 20 carbon atoms, an alkoxy group having 1 to 10 carbon atoms, an alkoxyalkyl group having 1 to 20 carbon atoms, an aryl group having 6 to 20 carbon atoms, an aryloxy group having 6 to 10 carbon atoms, an alkenyl group having 2 to 20 carbon atoms, an alkylaryl group having 7 to 40 carbon atoms, an arylalkyl group having 7 to 40 carbon atoms, an arylalkenyl group having 8 to 40 carbon atoms, or an alkynyl group having 2 to 10 carbon atoms;

R³ is a divalent hydrocarbon group crosslinking Cp¹R¹ and Cp²R² through a covalent bond and containing an element selected from the group consisting of silicon, germanium, phosphor, nitrogen, boron, and aluminum; and

m is 0 or 1.

According to the present invention, in the formula 1, M may be an element of group 4, such as Ti, Zr, or Hf.

In the formula 1, when m is 1, the metallocene compound has a bridged compound structure in which R³ crosslinks Cp¹R¹ and Cp²R²; and when m is 0, the metallocene compound has a non-crosslinked compound structure.

Non-limiting examples of the metallocene compound may include compounds such as BisIndenylZrCl₂, BisIndenylHfCl₂, Bis(1-butyl-3-methylcyclopentadienyl)ZrCl₂, Bis(cyclopentadienyl)ZrCl₂, rac-Ethylene-1,2-bis(1-indenyl)ZrCl₂, rac-Dimethylsilylene-bis(1-indenyl)ZrCl₂, (Cyclopentadienyl)IndenylZrCl₂, [Dimethylsilyl(η⁵-tetramethylCyclopentadienyl)(t-butylamido)]TiCl₂, etc.

On the other hand, the metallocene catalyst system of the present invention may further comprise a cocatalyst compound.

The cocatalyst compound may be a typical compound capable of activating the metallocene compound, preferably at least one compound selected from the group consisting of compounds represented by the following formula 2, 3 or 4:

R²²—[Al(R²¹)—O]ₐ—R²³ [Formula 2]

in the formula 2,

each of R²¹, R²² and R²³ is independently a hydrogen, a halogen, a hydrocarbyl group having 1 to 20 carbon atoms, or a halogen-substituted hydrocarbyl group having 1 to 20 carbon atoms,

a is an integer of 2 or more;

D(R³¹)₃ [Formula 3]

in the formula 3,

D is aluminum or boron, and

each of R³¹ is independently a halogen, a hydrocarbyl group having 1 to 20 carbon atoms, or a halogen-substituted hydrocarbyl group having 1 to 20 carbon atoms;

[L-H]⁺[Z(A)₄]⁻ or [L]⁺[Z(A)₄]⁻ [Formula 4]

in the formula 4,

L is a neutral or cationic Lewis base,

[L-H]⁺ or [L]⁺ is a bronsted acid,

H is hydrogen,

Z is an element of group 13, and

each of A is independently an aryl group having at least one hydrogen atom substituted with a halogen, a hydrocarbyl group having 1 to 20 carbon atoms, an alkoxy group having 1 to 20 carbon atoms, or a phenoxy group, or an alkyl group having 1 to 20 carbon atoms.

In order to allow the cocatalyst compound to have a more excellent activation effect, it is preferable that in the formula 2, R²¹ is methyl, ethyl, n-butyl, or isobutyl; in the formula 3, D is aluminum and R³¹ is methyl or isobutyl; or D is boron and R³¹ is pentafluorophenyl; and in the formula 4, [L-H]⁺ is a dimethylanilinium cation, [Z(A)₄]⁻ is [B(C₆H₅)₄]⁻, and [L]⁺ is [(C₆H₅)₃C]⁺.

In the formulas 2 and 3, the “hydrocarbyl” group may be a monovalent functional group in the form of a hydrocarbon removed of hydrogen atoms and include ethyl, phenyl, etc.

Non-limiting examples of the compound represented by the formula 2 may include methylaluminoxane, ethylaluminoxane, isobutylaluminoxane, butylaluminoxane, etc.

Non-limiting examples of the compound represented by the formula 3 may include trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminum methoxide, dimethylaluminum ethoxide, etc.

Non-limiting examples of the compound represented by the formula 4 may include trimethylammonium tetrakis(pentafluorophenyl)borate, triethylammonium tetrakis(pentafluorophenyl)borate, N,N-dimethylanilinium tetrakis(pentafluorophenyl)borate, N,N-dimethylanilinium n-butyltris(pentafluorophenyl)borate, N,N-dimethylanilinium benzyltris(pentafluorophenyl)borate, N,N-dimethylanilinium tetrakis(4-t-butyldimethylsilyl)-2,3,5,6-tetrafluorophenyl)borate, N,N-dimethylanilinium tetrakis(4-triisopropylsilyl)-2,3,5,6-tetrafluorophenyl)borate, N,N-dimethylanilinium pentafluorophenoxytris(pentafluorophenyl)borate, N,N-dimethyl-2,4,6-trimethylanilinium tetrakis(pentafluorophenyl)borate, trimethylammonium tetrakis(2,3,4,6-tetrafluorophenyl)borate, N,N-dimethylanilinium tetrakis(2,3,4,6-tetrafluorophenyl)borate, hexadecyldimethylammonium tetrakis(pentafluorophenyl)borate, N-methyl-N-dodecylanilinium tetrakis(pentafluorophenyl)borate, methyldi(dodecyl)ammonium tetrakis(pentafluorophenyl)borate, etc.

Here, the cocatalyst compound may be used in such an amount that the molar ratio of the metal contained in the cocatalyst compound with respect to one mole of the transition metal contained in the metallocene compound is in the range of 1:1 to 1:10,000, or 1:1 to 1:1,000, or 1:1 to 1:100.

The metallocene catalyst system of the present invention may further comprise an inert support to which the metallocene compound and the antistatic agent are affixed.

The inert support may include, but is not specifically limited to, typical organic or inorganic supports, preferably SiO₂, Al₂O₃, MgO, MgCl₂, CaCl₂, ZrO₂, TiO₂, B₂O₃, CaO, ZnO, BaO, ThO₂, SiO₂—Al₂O₃, SiO₂—MgO, SiO₂—TiO₂, SiO₂—V₂O₅, SiO₂—CrO₂O₃, SiO₂—TiO₂—MgO, bauxite, zeolite, etc.

For non-limiting example, the supported catalyst according to the exemplary embodiment can be prepared by suspending silica gel, slowly adding a cocatalyst compound (methylaluminoxane, etc.) under agitation, adding an antistatic agent and a metallocene compound, and then carrying out the steps of stirring, washing and drying.

In accordance with another exemplary embodiment of the present invention, there is provided a method for preparing a polyolefin that comprises performing gas-phase polymerization of at least one olefin monomer in the presence of the metallocene catalyst system.

In this regard, the olefin monomer may be at least one compound selected from the group consisting of an alpha-olefin having 2 to 20 carbon atoms, a diolefin having 1 to 20 carbon atoms, a cyclo-olefin having 3 to 20 carbon atoms, and a cyclo-diolefin having 3 to 20 carbon atoms.

Non-limiting examples of the olefin monomer may include alpha-olefins having 2 to 20 carbon atoms, including ethylene, propylene, 1-butene, 1-pentene, and 1-hexene; diolefins or cyclo-diolefins having 1 to 20 carbon atoms, including 1,3-butadiene, 1,4-pentadiene and 2-methyl-1,3-butadiene; cyclo-olefins having 3 to 20 carbon atoms, including cyclopentene, cyclohexene, cyclopentadiene, cyclohexadiene, norbonene, and methyl-2-norbonene; styrenes or substituted styrenes having a C₁-C₁₀ alkyl group, an alkoxy group, a halogen group, an amine group, a silyl group, a haloalkyl group, etc. bonded to the phenyl ring of a styrene; or mixtures thereof.

According to the present invention, the preparation method for polyolefin can provide higher efficiency in the gas-phase polymerization process.

Hereinafter, reference will be made to the accompanying drawings to describe the preferred embodiments of the present invention in further detail, which are given for illustration of the present invention and not intended to limit the scope of the present invention.

In the following preparation examples, all the processes were carried out in a Glove Box (manufactured by MBRAUN), removed of oxygen and kept under the water content of 0.1 ppm or below. Indene as used herein was cracked at high temperature in advance.

### Preparation Example 1

### Preparation of BisIndenylZrCl₂ Catalyst System Containing LiCl

99.79 g of Indene was dissolved in 300 ml of tetrahydrofuran (THF), and 2.5 M n-BuLi was added to the solution at −78° C. The resultant solution was gradually heated up to the room temperature, stirred for about 1 hour, and cooled down to −78 ° C. Then, 41.94 g of ZrCl₄ was added. After completion of the reaction for about 4 hours, a yellowish solid was yielded, filtered out and then washed with pentane. The solid product was removed of the remaining solvent under vacuum to obtain a BisIndenylZrCl₂ catalyst system containing LiCl. The content of LiCl in the catalyst system was about 11 wt. % with respect to the total weight of the metallocene compound.

¹H NMR: δ 7.64-7.62 (dd, 4H), δ 7.32-7.30 (dd, 4H), δ 6.50-6.48 (t, 2H), δ 6.18-6.17 (d, 4H)

### Preparation Example 2

### Preparation of BisIndenylHfCl₂ Catalyst System Containing LiCl

99.79 g of Indene was dissolved in 300 ml of tetrahydrofuran (THF), and 2.5 M n-BuLi was added to the solution at −35 ° C. The resultant solution was gradually heated up to the room temperature, stirred for about 1 hour, and cooled down to −35 ° C. Then, 57.65 g of HfCl₄ was added. After completion of the reaction for about 3 hours, a yellowish solid was yielded, filtered out and then washed with 20 ml of THF and hexane. The solid product was removed of the remaining solvent under vacuum to obtain a BisIndenylHfCl₂ catalyst system containing LiCl. The content of LiCl in the catalyst system was about 10.3 wt. % with respect to the total weight of the metallocene compound.

¹H NMR: δ 7.62-7.60 (dd, 4H), δ 7.30-7.27 (dd, 4H), δ 6.46-6.44 (t, 2H), δ 6.03-6.02 (d, 4H)

### Comparative Preparation Example 1

### Preparation of BisIndenylZrCl₂ Catalyst System Not Containing LiCl

All the BisIndenylZrCl₂ catalyst system synthesized according to the preparation example 1 was dissolved in an excess of toluene and filtered out to eliminate LiCl. The resultant catalyst was dissolved in toluene once more again and then filtered out to obtain a BisIndenylZrCl₂ catalyst removed of LiCl. The content of LiCl in the catalyst was less than 0.1 wt. % with respect to the total weight of the metallocene compound.

### Comparative Preparation Example 2

### Preparation of BisIndenylHfCl₂ Catalyst System Not Containing LiCl

All the BisIndenylHfCl₂ catalyst system synthesized according to the preparation example 2 was dissolved in an excess of toluene and filtered out to eliminate LiCl. The resultant catalyst was dissolved in toluene once more again and then filtered out to obtain a BisIndenylHfCl₂ catalyst removed of LiCl. The content of LiCl in the catalyst was less than 0.1 wt. % with respect to the total weight of the metallocene compound.

### Preparation Example 3

### Preparation of Supported Catalyst Containing LiCl

1800 g of silica (dehydrated at 200° C., Grace Sylopol-948) was put in a 100L reactor. 9L of toluene and 10.9 kg of 10 wt. % methylaluminoxane (MAO) in toluene were added to the reactor. The mixture was stirred at the room temperature for about 2 hours for reaction. To the mixture were added about 5.77 g of the catalyst system of the preparation example 1 and about 28.22 g of the catalyst system of the preparation example 2. The resultant mixture was kept at the room temperature for about 2 hours for reaction. After completion of the reaction, the slurry was settled down and the supernatant was filtered out. A supported catalyst was obtained through the subsequent steps of washing with hexane and drying under vacuum.

### Comparative Preparation Example 3

### Preparation of Supported Catalyst Not Containing LiCl

The procedures were performed in the same manner as described in the preparation example 3, excepting that about 5.77 g of the catalyst of the comparative example 1 and about 28.22 g of the catalyst of the comparative example 2 were used in place of the catalyst systems of the comparative examples 1 and 2.

The primary compositions of the supported catalysts obtained in the preparation example 3 and the comparative preparation example 3 are presented in Table 1.

TABLE 1

| | | Comparative Preparation |
|---|---|---|
| | Preparation Example 3 | Example 3 |
| Al (wt. %) | 17.78 | 17.67 |
| Zr (wt. %) | 0.041 | 0.055 |
| Hf (wt. %) | 0.346 | 0.499 |
| LiCl (ppm) | 2076 | <<30 |

### Example

### Preparation of Polyethylene

The catalyst system obtained in the preparation example 3 was used to prepare polyethylene. In this regard, a gas-phase fluid bed pilot reactor was used, and 1-hexene was consecutively added to cause the reaction. The work results are presented in Table 2.

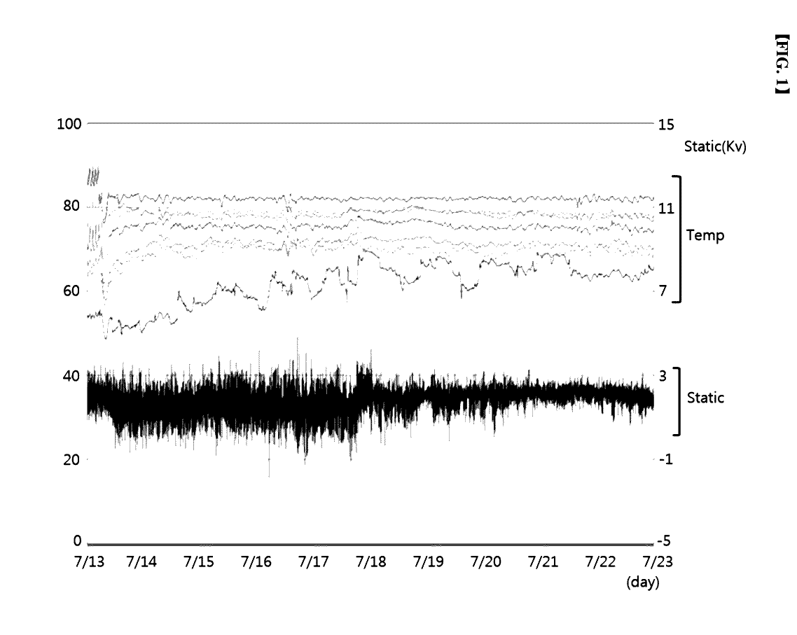

In the polyethylene preparation process, a static probe was used to measure the change of temperature on the inner wall of the reactor. The measurement results are presented in FIG. 1, where the static fluctuation was ±0.63 Kv.

As can be seen from the fluctuation of the temperature lines in FIG. 1, the temperature on the inner wall of the reactor was maintained in a stable manner, allowing a stable work for 10 days.

### Comparative Example

### Preparation of Polyethylene

The catalyst system obtained in the comparative preparation example 3 was used to prepare polyethylene. In this regard, a gas-phase fluid bed pilot reactor was used, and 1-hexene was consecutively added to cause the reaction. The work results are presented in Table 2.

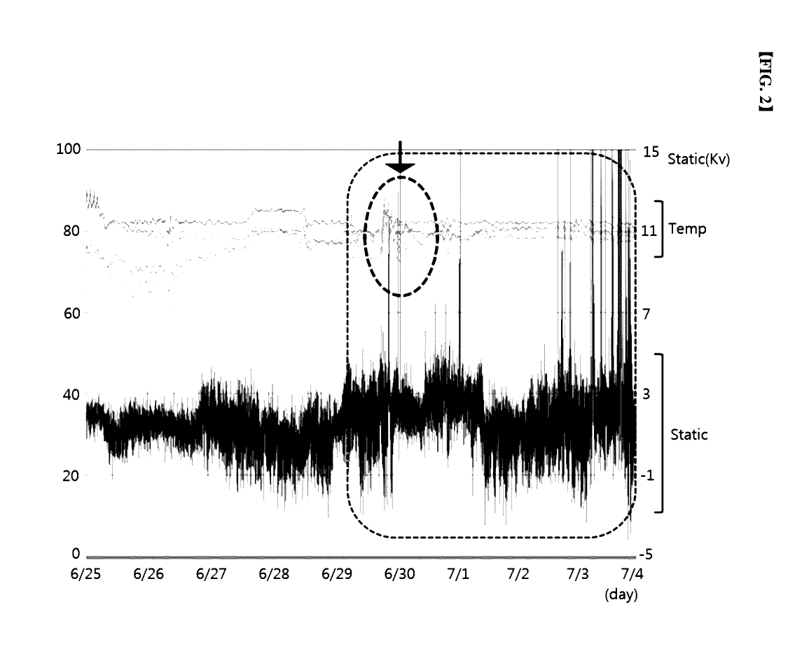

In the polyethylene preparation process, a static probe was used to measure the change of temperature on the inner wall of the reactor. The measurement results are presented in FIG. 2, where the static fluctuation was ±1.47 Kv.

As can be seen from the fluctuation of the temperature lines in FIG. 2, in about 35 hours after the addition of the catalyst, the static probe value dropped to a negative value and the temperature on the inner wall of the reactor abruptly increased (the hot spot as indicated by the arrow) to cause sheet and chunk, making it impossible to continue a work for 60 hours or more.

TABLE 2

| | Example | Comparative Example |
|---|---|---|
| C2 PP (K/G) | 14.99 | 15.16 |
| Static (Kv) | 1.99 ± 0.63 | 0.20 ± 1.47 |
| Temp. (° C.) | 82.00 | 81.92 |
| UBD (g/cc) | 0.271 | 0.251 |
| H2/C2 (%) | 0.018 (1.2) | 0.015 (0.8) |
| C6/C2 (%) | 2.79 | 4.09 |
| Activity (kgPE/kgCat.) | 3100 | 4250 |
| MI (g/min) | 1.23 | 1.32 |
| Bulk Density (g/cm³) | 0.443 | 0.43 |

UBD: Upper bed bulk density
MI: Melt index
H2/C2 (%): Hydrogen/ethylene molar ratio * 100 in the reactor
C6/C2 (%): 1-Hexene/ethylene molar ratio * 100 in the reactor

1. A metallocene catalyst system for olefin polymerization comprising:
a metallocene compound; and
at least one antistatic agent selected from an alkali metal salt and an alkaline earth metal salt.

2. The metallocene catalyst system for olefin polymerization as claimed in claim 1, wherein the antistatic agent is a compound comprising at least one metal selected from the group consisting of lithium, sodium, potassium, rubidium, cesium, francium, calcium, strontium, barium, and radium.

3. The metallocene catalyst system for olefin polymerization as claimed in claim 1, wherein the antistatic agent is at least one compound selected from the group consisting of lithium chloride, sodium chloride, and calcium chloride.

4. The metallocene catalyst system for olefin polymerization as claimed in claim 1, wherein the antistatic agent is used in an amount that the molar ratio of a metal contained in the antistatic agent with respect to one mole of a transition metal contained in the metallocene compound is in the range of 1:0.001 to 1:100.

5. The metallocene catalyst system for olefin polymerization as claimed in claim 1, wherein the metallocene compound is a compound represented by the following formula 1: 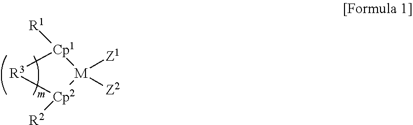
in the formula 1,
M is a transition metal of group 4;
Cp¹ and Cp² are the same or difference and each is independently any one radical selected from the group consisting of cyclopentadienyl, indenyl, 4,5,6,7-tetrahydro-1-indenyl, and fluorenyl and replaceable by at least one hydrocarbon group having 1 to 20 carbon atoms;
R¹ and R² are the same or difference and each is independently a hydrogen, an alkyl group having 1 to 20 carbon atoms, an alkoxy group having 1 to 10 carbon atoms, an alkoxyalkyl group having 1 to 20 carbon atoms, an aryl group having 6 to 20 carbon atoms, an aryloxy group having 6 to 10 carbon atoms, an alkenyl group having 2 to 20 carbon atoms, an alkylaryl group having 7 to 40 carbon atoms, an arylalkyl group having 7 to 40 carbon atoms, an arylalkenyl group having 8 to 40 carbon atoms, or an alkynyl group having 2 to 10 carbon atoms;
R³ is a divalent hydrocarbon group crosslinking Cp¹R¹ and Cp²R² through a covalent bond and containing an element selected from the group consisting of silicon, germanium, phosphor, nitrogen, boron, and aluminum; and
m is 0 or 1.

6. The metallocene catalyst system for olefin polymerization as claimed in claim 1, further comprising at least one cocatalyst compound selected from the group consisting of compounds represented by the following formula 2, 3 or 4:
R²²—[Al(R²¹)—O]ₐ—R²³ [Formula 2]
in the formula 2,
each of R²¹, R²² and R²³ is independently a hydrogen, a halogen, a hydrocarbyl group having 1 to 20 carbon atoms, or a halogen-substituted hydrocarbyl group having 1 to 20 carbon atoms,
a is an integer of 2 or more;
D(R³¹)₃ [Formula 3]
n the formula 3,
D is aluminum or boron, and
each of R³¹ is independently a halogen, a hydrocarbyl group having 1 to 20 carbon atoms, or a halogen-substituted hydrocarbyl group having 1 to 20 carbon atoms;
[L-H]⁺[Z(A)₄]⁻ or [L]⁺[Z(A)₄]⁻ [Formula 4]
in the formula 4,
L is a neutral or cationic Lewis base,
[L-H]⁺ or [L]⁺ is a bronsted acid,
H is hydrogen,
Z is an element of group 13, and
each of A is independently an aryl group having at least one hydrogen atom substituted with a halogen, a hydrocarbyl group having 1 to 20 carbon atoms, an alkoxy group having 1 to 20 carbon atoms, or a phenoxy group, or an alkyl group having 1 to 20 carbon atoms.

7. The metallocene catalyst system for olefin polymerization as claimed in claim 6,
wherein in the formula 2, R²¹ is methyl, ethyl, n-butyl, or isobutyl;
wherein in the formula 3, D is aluminum and R³¹ is methyl or isobutyl; or D is boron and R³¹ is pentafluorophenyl; and
wherein in the formula 4, [L-H]⁺ is a dimethylanilinium cation, [Z(A)₄]⁻ is [B(C₆H₅)₄]⁻, and [L]⁺ is [(C₆H₅)₃C]⁺.

8. The metallocene catalyst system for olefin polymerization as claimed in claim 6, wherein the cocatalyst compound is used in an amount that the molar ratio of a metal contained in the cocatalyst compound with respect to one mole of a transition metal contained in the metallocene compound is in the range of 1:1 to 1:10,000.

9. The metallocene catalyst system for olefin polymerization as claimed in claim 1, further comprising an inert support having the metallocene compound and the antistatic agent affixed thereto.

10. A method for preparing a polyolefin, comprising:
performing gas-phase polymerization of at least one olefin monomer in the presence of the metallocene catalyst system as claimed in claim 1.

11. The method as claimed in claim 10, wherein the olefin monomer is at least one compound selected from the group consisting of an alpha-olefin having 2 to 20 carbon atoms, a diolefin having 1 to 20 carbon atoms, a cyclo-olefin having 3 to 20 carbon atoms, and a cyclo-diolefin having 3 to 20 carbon atoms.
